(19) United States
(12) Patent Application Publication
(10) Pub. No.: US 2018/0155971 A1
(43) Pub. Date: Jun. 7, 2018

(54) HINGE WITH DEFINED HALT POSITIONS

(71) Applicant: ELESA S.p.A., Milano (IT)

(72) Inventor: Alberto Bertani, Monza (IT)

(21) Appl. No.: 15/833,202

(22) Filed: Dec. 6, 2017

(30) Foreign Application Priority Data
Dec. 7, 2016 (IT) 102016000124482

(51) Int. Cl. E05D 11/10; E05D 3/02

(52) U.S. Cl. CPC E05D 11/1064; E05Y 2900/20; E05Y 2900/132; E05D 3/02

(57) ABSTRACT

Hinge for the support and the maneuvering of doors, made up of two wing elements and provided with means for attachment to a frame part and respectively to a door portion, as well as mutually reinforcing means in a pivoting zone, the means being constituted by appendices internally hollow in the form of a cylindrical body projecting from the wing elements, characterized in that at least one of the appendices of the wings provides on the inner surface axial grooves suitable for housing a push-engagement element housed inside a pivot pin of the wing elements and protruding from it.

### TECHNICAL FIELD

The present invention concerns a hinge which has multiple halt positions, i.e. a hinge which can remain stationary in an intermediate position without the help of outer mechanical supports, such as for example hooks, chains, or other elements which need to be mounted.

### BACKGROUND OF THE INVENTION

Hinges of this type are available on the market, and they are employed in industrial equipment, for example for the connection of hoods of mechanical equipment to the frame, or of doors to automatic vending machines, to electric cabinets, to banking devices, or in protection carters, access gates or the like.

This type of hinge was met with considerable success on the market, also in the light of the fact that it meets the need of operators and maintenance personnel of having a gate, or a hood, which keeps an open, secure position, however chosen, and that it does not interfere—if only incidentally—with the action thereof.

The hinges thus made found on the market provide a system of mutual engagement of two hinge elements, consisting of locking elements between a central pivot and one—or both—hinge elements. Thrust springs are provided, made of steel or rubber, which are associated with further additional elements, such as for example steel spheres and screws.

U.S. Pat. No. 5,412,842 owned by Southco Inc. concerns for example a conventional-type hinge, wherein suitable means are provided apt to retain in specific mutual positions the two hinge wings. Said devices consist of a spring-sphere pair, housed in the wall-fastened wing, and of holes and grooves provided on the wings so that the sphere-shaft coupling keeps the door in a predefined secure position, unless a strong pressure is imparted on the gate.

However, such a solution is particularly complex to accomplish, since all the recesses obtained must be perfectly in axis to be able to effectively lock the gate, and since rather difficult mounting operations are necessary, with the risk that the sphere departs from its seat during the installation.

Furthermore, since the engaging means are basically made of steel, they are complex to be realized and have a poor tribologic coupling. Finally, the springs apt to drive the spheres are partially in sight: therefore, an unexpected shock could unlock them from the original position, for example during the transport phase or the mounting phase. Such an event could affect the functionality of the means.

In order to make the hinge structure simpler, the Applicant duly submitted Italian patent no. 1365898, aimed at protecting a hinge having multiple halt positions, the hinging elements of which provided on the respective wings have on the engagement surfaces ribs and longitudinal recesses in mutual engagement. This invention, which substantially provided to insert no retaining element, proved particularly useful in case of relatively light loads, but it highlighted some problems on heavier loads

In order to solve this matter, the applicant has filed the Italian patent 1398735, apt to describe a novel solution, in which the thrust element was inserted inside a slot provided on the wing without the grooved cylindrical body, and consisted of an elastic element at X ending at a wedge end. The steady engagement between the two wings was granted by the engagement of the wedge with the groove provided onto the cylindrical body and by the elastic force of an X-shaped element provided upstream the wedge element. After the application of a force to a movable door (that is, to the wall fixed to the movable door) the wedge element tends to shrink, in order to allow the detachment of the said wedge from the groove provided on the cylindrical element of the other wing.

However, also this solution appears rather difficult to realize, and shows several disadvantages during the mounting phase, because the correct placement of the engagement elements could become difficult: as a matter of fact, this kind of hinge is relatively small in size.

Furthermore, this solution appears particularly subjected to the changes in temperature and humidity of the environment in which it is used, since the elastic force of the X-shaped element it is connected to the properties of the plastic material with which it is used.

Therefore, it is object of the present invention to find a new type of hinge with defined halt positions, which is capable of overcoming the above-said disadvantages, and in particular which provides a sealing system easy to manufacture and mount, which is capable of keeping the hinge in a secure position when it is in the desired preset position, with no limitation to the borne load, and which it is independent of the environment in which it is used.

The above-said object is achieved through a hinge for door support and maneuvering, consisting of two wing elements, provided with means for fastening to a frame part and to a door part, respectively, as well as mutual-hinging means in a pivoting area, said means consisting of appendixes projecting from said wing elements, wherein said appendixes are shaped as a hollow cylindrical body characterized in that at least one of said appendixes of said wings has axial grooves provided on the internal surface, said grooves being apt to accommodate a thrust element inside a pivot member of said wing elements and protruding from said pivot element. The dependent claims refer to preferential feature.

### BRIEF DESCRIPTION OF THE DRAWINGS

Other features and advantages of the invention will in any case be more evident from the following detailed description of some preferred embodiments, given purely by way of a non-limiting example, and illustrated in the attacked drawings, wherein:

FIG. 1 shows a front view of the hinge ready for installation, of which

FIG. 2 is a section view along line C-C;

FIG. 3 is a partially removed perspective view of the hinge of FIG. 1;

FIG. 4 is a front view of one of the two wings of the hinge according the invention, of which

FIG. 5 is a top view;

FIG. 6 is a front view of the wing opposed to the wing depicted in FIG. 2, of which

FIG. 7 is the top view;

FIG. 8a-8d are respectively lateral view, rear view, sectional view along the A-A line and front view of the thrust element of a particular embodiment of the invention;

FIG. 9a a 9c are respectively front view, lateral view and sectional view along the line B-B of the pivot element according the invention; and

FIGS. 10a to 10d are perspective views aimed at showing the positions which the various embodiments of the hinge according to the invention can take up during operation, with various angles.

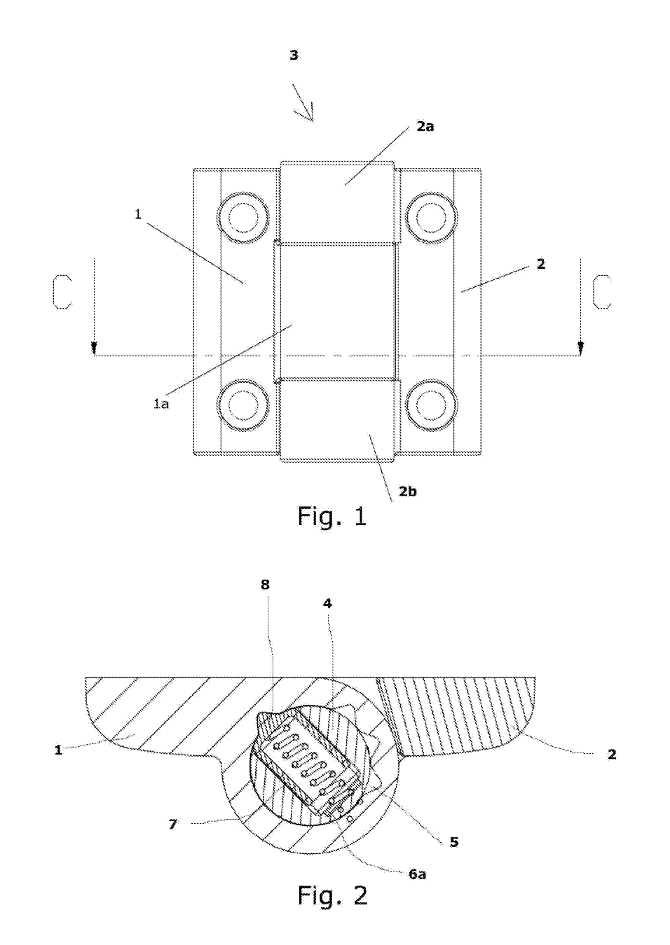

### DESCRIPTION OF A PREFERRED EMBODIMENT

The hinge according to the invention consists of two main elements 1 and 2, which can be identified as wings or as hinge bodies-generally molded of thermoplastic material, but which can be made also of other synthetic materials, or of rubber or of metal-shaped so as to have a mutual engagement area 3, into which a pivoting element 4 is introduced.

The mutual engagement area 3 consists of the association of respective appendixes which project from both wings: in particular a cylindrical body 1a projecting from wing 1 is provided, and a pair of bushes 2a, 2b, projecting from wing 2, for the introduction and the sealing of pivoting element 4.

Pivoting element 4 is axially mounted starting from one of the ends and is fastened by means of constraint elements (not shown, known per se).

According to a first feature of the invention, the pivot element 4 consists of a cylindrical body, externally shaped with a polygonal base and provided along the external wall with a slot 6 apt to house an halt system composed of a wedge element 7 and a harmonic shock absorber 8, such as a spiral spring (as will be defined below, for simplicity purposes contained in it.

As it can well observed in the section of FIG. 2, the wedge element 7 is internally hollow, in order to house inside it at least a spring element 8, firmly maintained in position at the two ends in the beating surface 7a of said element 7 and at the bottom wall of said slot 6. In such a way, it will be granted that the system composed by the element 7 and the spring element 8 is perfectly and autonomously functional, after the insertion of the pivot element 4.

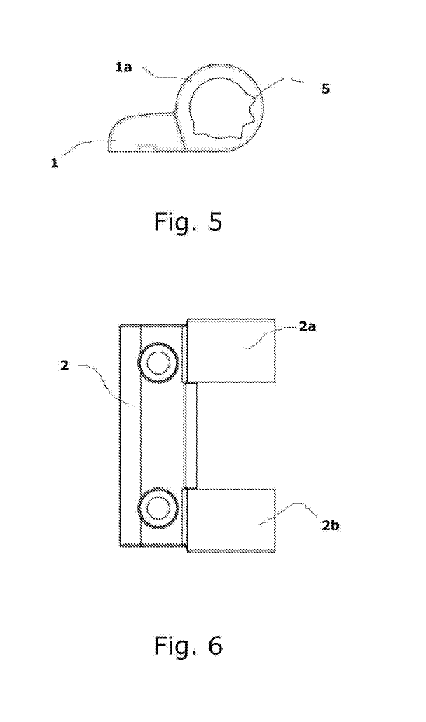

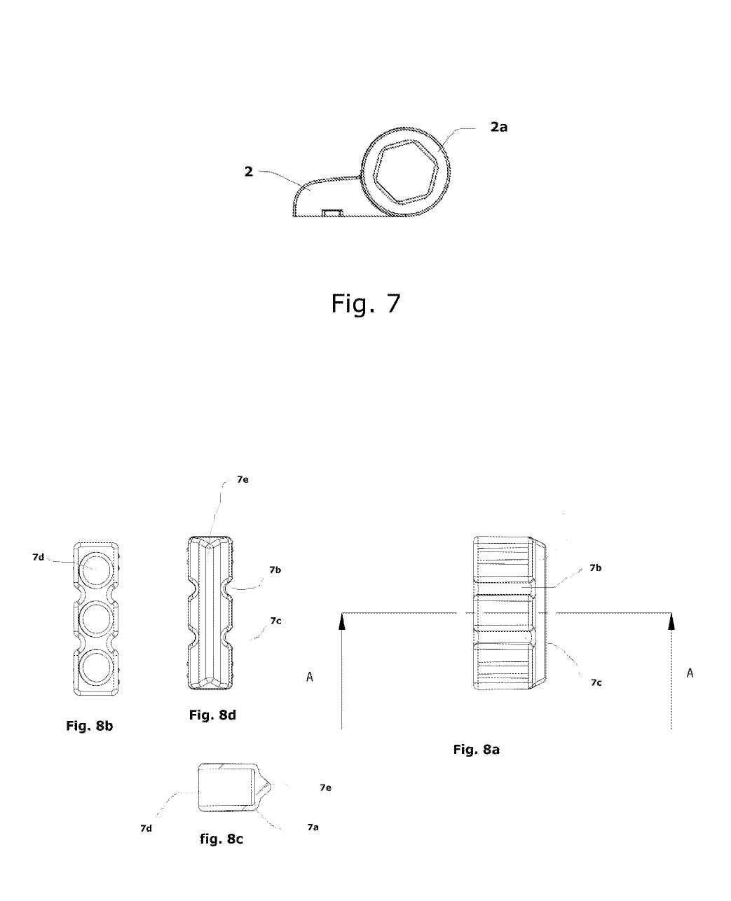

FIG. 2 and, more precisely, FIG. 5 show the shape and the location of the said axial grooves 5 located within said cylindrical appendix 1a acting as a engagement member of the wing 1: particularly, it could be noted that the corresponding blunt profile in order to help the sliding movement of the door, and with the vertex defined to guarantee the steady position of the wedge element 7.

In the specific embodiment of FIGS. 8a-8d, it is shown a wedge element 7 having a specific tripartition, defined by the presence of two facing couples of external grooves 7b, 7c that surround—at it is well illustrated in FIG. 8b—three identical cavities 7d apt to house identical spring elements 8, said spring elements being characterized also in an identical load. On the topo of each cavity 7d it is provided the beating surface 7a. Finally, the tip 7e is provided on the top of the wedge element 7, said tip 7e having substantially triangular shape, with the contour slightly blunt. Said conformation is apt to guarantee the correct engagement with the groove 5; contemporarily, it guarantees the easy disengagement.

It could be noted the front beating housing 7a for the spring 8, in order to better comprehend the novel solution.

The pivot 4, shown in the FIGS. 9a a 9c, is composed of a cylindrical body having at its ends a polygonal shaping and centrally bearing a housing slot 6 apt to move the halt system composed of the wedge element 7 and of the spring 8. The slot has a substantially rectangular profile and it provides on the bottom surface, a circular cavity 6a in order to house the spring 8, and to hold in place the same.

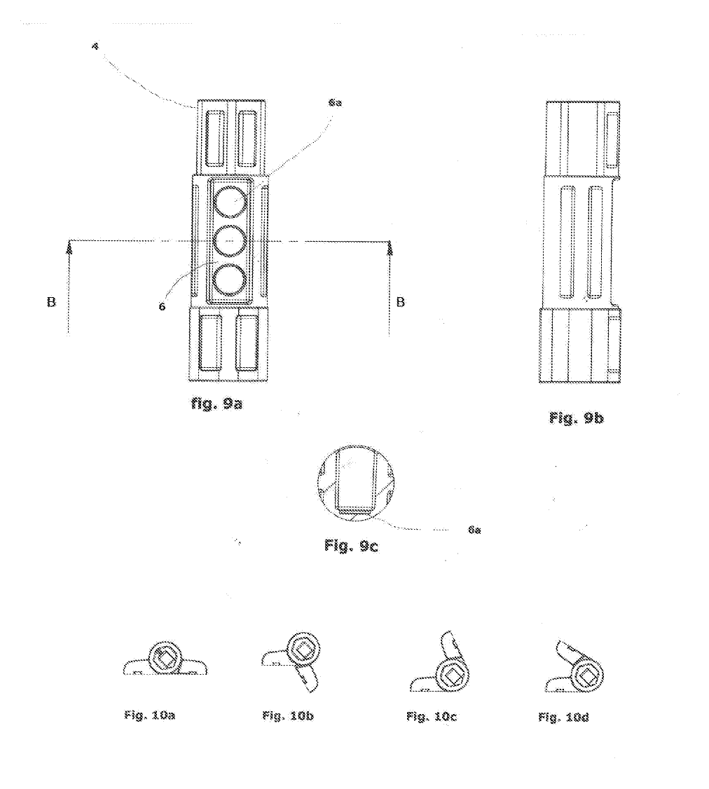

Further, as it is also shown in the operation of the FIGS. 10a-10d, the body 1a has a particular arrangement of the grooves 5, in order to obtain angles respect to the table top of the body 1, corresponding to the angles that the hinged door will take respect to the wall onto which the hinge was assembled. Particularly, in FIG. 4 the four preferred position are illustrated that are matching with the position usually requested by the market, i.e. 0° (FIG. 10a), 80° (FIG. 10b), +115° (FIG. 10c) and 150° (FIG. 10d).

Of course, the solution of a tripartite hinge is just described as an example: it could be provided more or less springs, likely at least one spring, maintaining the modular structure of the wedge element 7. Likewise, the number and the angle of the grooves 5 could vary according to the different requests of the client.

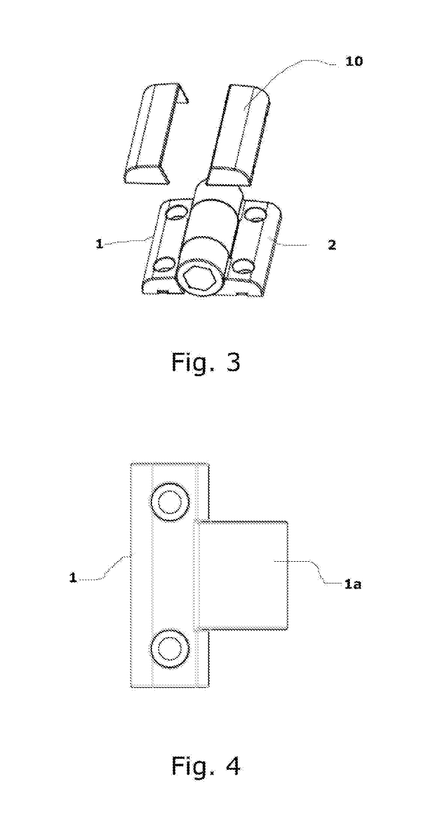

Assembling the hinge is relatively easy: it is sufficient to insert the springs 8 in the wedge element 7, in order to house the assembly obtained in such a manner inside the slot 6 provided into the pivot element 4. Subsequently, the worker inserts the pivot element 4 inside the reciprocating zone 3, and plugs the pivot elements 4 at the ends. After the adjustment of the wings to the door and to the wall of the machine, the worker defines—just pushing—the screw-cover caps 10 shown in FIG. 3.

In such a way, the structure of the hinge is able to realize the objects desired, obtaining a hinge easy to mount, apt to resist to high pressures in a stable position, and—contemporarily—apt to guarantee a correct movement of a door relative to the wall of a machine, maintaining pre-set positions.

Such a manufactured structure consents to overcome the solutions of the prior art, maintaining the spring element 8 hidden to the worker. This feature certainly appears pleasing to the eye, but it is also appears as a protective feature against the agents, like powder or humidity, that could limit the ability of the spring to operate in the correct manner.

Furthermore, the presence of housing chambers of the spring allows the operator to prepare a fast assembly, without the risk of misalignments and incorrect insertion of the wedge in position.

As it could be easily understood, all the elements that make up the hinge can be composed of any type of material apt to offer the desired characteristics of lightness and strength. In particular, the solution described up to now is totally composed of synthetic material, the only metal element being at most the amortizing body: however, the latter is very easy to assemble and is totally enclosed within the seats designated, significantly reducing wear or corrosion, and thus significantly increasing the life of the hinge.

Moreover, the angles that the hinge can assume in the operation may also be different from those shown in the figures, although obviously they must be pre-defined in the molding phase.

1) Hinge for the support and the maneuvering of doors, made up of two wing elements and provided with means for attachment to a frame part and respectively to a door portion, as well as mutually reinforcing means in a pivoting zone, said mutually reinforcing means being constituted by appendices internally hollow in the form of a cylindrical body projecting from said wing elements, wherein at least one of said apendices of said wings provides on the inner surface axial grooves suitable for housing a push-engagement element housed inside a pivot pin of said wing elements and protruding from it.

2) The hinge as in claim 1), wherein said pivot element is composed by a substantially cylindrical body provided along the wall of a slot apt to house a halt system composed of a wedge element and of a harmonic shock absorbing body contained in it.

3) The hinge as in claim 2), wherein said wedge element is internally hollow, and it houses inside it at least a harmonic shock absorbing body, said harmonic shock absorbing body being held in a steady place at the two ends on the on the batting surface of the said wedge element and on the bottom surface of said slot.

4) The hinge as in claim 2) wherein said wedge element provides externally at least a couple of opposing grooves, to said grooves corresponding—symmetrical with respect to said pair of grooves—identical cavities for housing said harmonic shock absorbing bodies, and at the head of each said cavity, a striking surface is provided.

5) The hinge as in claim 4) wherein said wedge element provides two couples of grooves that contour three cavities apt to house respective harmonic shock absorbing bodies.

6) The hinge as in claim 2) wherein said slot has a substantially rectangular profile, and provides on the bottom surface at least circular cavities apt to house said harmonic shock absorbing bodies.

7) The hinge as in claim 1) wherein said grooves form angles respect to the support plane of the principal wing element, said angles corresponding to the angles that the hinged door assumes respect to the wall onto which the hinge is mounted, equal to 80°, +115° and 150°.

8) The hinge as in claim 1) wherein there is a couple of bushings protruding from the wing opposite the said first wing, said bushings being apt to insert and hold the pivot element.

9) The hinge as in claim 2) wherein said harmonic shock absorbing bodies are coil springs.
